(19) United States
(12) Patent Application Publication
(10) Pub. No.: US 2002/0017393 A1
(43) Pub. Date: Feb. 14, 2002

(54) Stable patch cords for lan test instruments

(76) Inventor: Charles C. Hanna-Myrick, Bothell, WA (US)

Correspondence Address: TREXLER, BUSHNELL, GIANGIORGI, BLACKSTONE & MARR, LTD., 105 W. ADAMS STREET, CHICAGO, IL, 60603, US

(21) Appl. No.: 09/876,295

(22) Filed: Jun. 7, 2001

Related U.S. Application Data
(60) Provisional application No. 60/216,619, filed on Jul. 7, 2000.
(60) Provisional application No. 60/264,111, filed on Jan. 25, 2001.

(51) Int. Cl. H01B 11/02

(52) U.S. Cl. 174/113 R

(57) ABSTRACT

A cable which includes eight coaxial cables. The shields of pairs of 50 Ohm coaxial cables are connected together at the ends with copper tape to form a desired 100 Ohm differential impedance. Since the impedance of the cable is set by the diameter of an inner conductors and the corresponding dielectric, the impedance is independent of proximity of adjacent pairs, or the proximity of hands or other conductive surfaces. As such, the stability of such a cable is improved over a typical four pair cable. Additionally, the conductors can always be oriented the same way within the plug. Test instruments can make stable measurements including “return loss” measurements when using test cable consisting of eight coax conductors properly connected together to connect to cable installations being measured. Attenuation or insertion loss of the test cables on test instruments can be compensated for by means of calibration of the instrument.

### BACKGROUND

With the ever increasing data throughput in computer interconnect wiring of Local Area Networks (LAN), requirements of data conductors have become more stringent. One of the requirements relates to “return loss”. When a signal is launched down a cable pair, discontinuities in the cables, connectors, transition points, etc. all can cause reflections. “Return loss” is a measure of how much signal is reflected as a result of these discontinuities. Recent standards have added requirements for measuring the “return loss”. It is advantageous to have “return loss” be consistent while measuring the links of a LAN. Unfortunately, the “return loss” of patch cables used as cords on test instruments can vary considerably with movement and handling of the test instrument and associated cable.

Others have tried and attempted solutions to these problems. For example, one attempt to overcome these problems is to “bond” or fuse together pairs of wires. Cables formed of such “bonded” pairs have been tested, and appear to result in a “return loss” which changes or is altered considerably by motion, twisting and handling the cable. The proximity of a user's hands as well as movement of adjacent pairs of wires as the cable is handled results in the capacitance, and hence the “return loss” of the cable, changing.

Another approach to this problem is to place a plastic cruciform in the center of the cable, between pairs of wires. The cruciform works to effectively separate adjacent pairs of wires. Nevertheless, handling, twisting and movement of the cable still affects the “return loss”.

Yet another approach to this problem is to use a cable in which each pair of wires is wrapped with a metalized Mylar shield. The entire cable, consisting of four pairs of wrapped wires, is wrapped with a braid. While more stable than either of the other approaches, it does not provide the desired results. For example, if the cable is twisted too much, the “return loss” suddenly changes. Also, over time, the metal coating on the Mylar tends to flake off the base material which can result in alteration of the electrical characteristics of the cable.

In general, none of the aforementioned approaches to the problems has provided sufficient stability to accurately measure the links needed to be measured.

An RJ45 connector 10 is shown in FIGS. 1 and 2. Such a connector 10 is common in computer networking, and consists of a cable 12 which contains eight wires and terminates in a plastic housing or plug 14. More specifically, the eight wires terminate at pins 16 which are exposed at the end of the plug 14. The wires (and corresponding pins 16) are numbered 1 though 8. The plug 14 is insertable in a corresponding receptacle, and causes the pins 16 on the connector 10 to conductively contact corresponding pins in the receptacle. The overall structure and operation of an RJ45 connector is well known in the art.

Another problem besides varying “return loss” relates to the fact that most cables, such as cables which terminate at an RJ45 connector, consist of four pairs of twisted wires, where each pair is twisted at a different rate to minimize crosstalk within the cable (i.e. crosstalk between different pairs of wires in the cable). Further, the four pairs of twisted wires are then twisted, usually relatively slowly, along the length of the cable. When the cable is cut to an RJ45 connector (i.e. when the cable is cut so that it can be engaged with an RJ45 connector), the overall cable must be positioned, i.e. rotated, so that the pairs of wires to be connected to pins 1, 2 and 7, 8 of the RJ45 connector 10 go directly to their respective holes 18 in the plug 14 for termination with their respective pins 16. In other words, in order to avoid crosstalk, there should be no cross-overs between wires 1 and 2, and wires 7 and 8.

Obviously, because the wires are twisted in the cable 12, when the cable 12 is cut such as for connection to an RJ45 connector, the pairs of wires can be in any number of different orientations. Regardless of the orientation, the wires must be engaged with the RJ45 connector in the following order to correspond with the pins 16 at the end of the plug 14: 1, 2, 3, 4, 5, 6, 7, 8. FIG. 3 illustrates four possible wire orientations where each orientation is relatively advantageous. More specifically, termination of each of the wires with its respective pin 16 (i.e. insertion of each of the wires in its respective hole 18 in the plug 14) in an RJ45 connector 10 would be relatively easy to achieve as a result of the orientation of the wires. In FIG. 3 (as well as FIG. 5 which will be described later), the circle around each pair of wires indicates that the wires are twisted together. Obviously, looking at the end of the cable after the cut, the wires would be spiraled together.

Because the wires must be engaged with the RJ45 connector in the order: 1, 2, 3 . . . 8, the pair sequence of each of the orientations shown in FIG. 3 is as represented by the arrows depicted in FIG. 4, respectively from left to right. Hence, for the left-most orientation shown in FIG. 3, the pair sequence is left, top, bottom and right, and this is represented by the left-most arrow shown in FIG. 4, where the arrow starts at the left and points up, down and finally to the right.

While FIG. 3 illustrates four possible wire orientations, where each orientation is advantageous, other wire orientations are possible which are not as advantageous. FIG. 5 illustrates four other possible wire orientations, where each orientation is not nearly as advantageous as those shown in FIG. 3 due to the position of each of the wires relative to the other wires. In each of the wire orientations shown in FIG. 5, all four pairs of wires would need to be twisted or untwisted a half turn to insert the wires into the plug 14 of an RJ45 connector 10 (see FIG. 1). This results in degraded and inconsistent crosstalk.

### OBJECTS AND SUMMARY

An object of the present invention is to provide a stable patch cable so that the links in a local area network (“LAN”) can be accurately measured.

Another object of the present invention is to provide a patch cable that is resistant to change and alteration of the “return loss” of the links being measured when the cable is handled.

Another object of the present invention is to provide a consistent way of dressing the wires from the ends of manufactured cables to the contacts (such as the pins of an RJ45 connector), to achieve reduced and consistent crosstalk.

Briefly, and in accordance with at least one of the foregoing objects, an embodiment of the present invention provides a cable which includes eight coaxial cables. Each of the coaxial wires includes a central conductor that is centered inside and insulated from an outer tubular conductor which is covered by an insulating jacket. Preferably, each of the coaxial cables are 50 Ohms, and the shields of pairs of the 50 Ohm coaxial cables are connected together at the ends with copper tape to form a desired 100 Ohm differential impedance. Since the impedance of the cable is set by the diameter of an inner conductors and the corresponding dielectric, the impedance is independent of proximity of adjacent pairs, or the proximity of hands or other conductive surfaces. As such, the stability of such a cable is improved over a typical cable. Additionally, the conductors can always be oriented the same way when entering the plug. In contrast, a prior art cable entering an RJ45 connector will have different orientations from one end to the other. Additionally, it has been found that cables made from eight coaxial cables and connected together properly are much more stable when measuring “return loss” as the cable is handled, moved, flexed and twisted. Individual conductors can be repeatedly and consistently assembled in the plug, giving more consistent results from one assembly to the next.

Test instruments can make stable measurements when connected to the cable, including “return loss” measurements using a test cable consisting of eight coax conductors properly connected together to connect to cable installations being measured. Attenuation and insertion loss of the test cables on test instruments can be compensated for by means of calibration of the instrument.

Another characteristic of using conventional cable is that wire pairs 1 & 2, 4 & 5, and 7 & 8 are connected to adjacent pins, and therefore the pair of wires do not spread out to go through the RJ45 connector. However the wire pair connected to pins 3 & 6 spread out to the sides of pins 4 & 5. This cases two problems. One problem is that either wire to pin 3 or the wire to 6 must cross over the wires to pins 4 and 5. Manufacturing variations of how this is done cause variations in crosstalk within the plug. The other problem that this creates is that the wires and associated pins are spread apart, giving a rise in impedance as the signal passes through the connector. This rise in impedance degrades the “return loss” of the 3-6 pair considerably.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 is an enlarged frontal view of a conventional RJ45 connector;

FIG. 2 is an enlarged side view of a conventional RJ45 connector;

FIG. 3 provides diagrammatic illustrations of the four possible different wire orientations within a cable;

FIG. 4 illustrates arrows which represent the pair sequences of the wire orientations shown in FIG. 3;

FIG. 5 is much like FIG. 3 and provides diagrammatic illustrations of four different wire orientations, but shows wire orientations which are not nearly as advantageous with regard to connecting the cable to an RJ45 connector;

FIG. 6 is a diagrammatic illustration of one end of a patch cable which is in accordance with an embodiment of the present invention (where the cable has two ends, but the other end looks effectively the same as shown);

FIG. 7 is a side elevational view of the cable shown in FIG. 6, where the wires are oriented for positioning in an RJ45 connector, such as the connector shown in FIGS. 1 and 2;

FIG. 8 is a diagrammatic end view of a possible orientation of the coaxial cables within the cable shown in FIGS. 6 and 7, after the cable has been cut; and

FIG. 9 is a schematic view of the cable shown in FIGS. 6-8, showing wires connecting the ends of the coaxial cable pairs together, along with wires connected to the wire pairs connected to test instrument ground at the test instrument end possibly through terminating resistors.

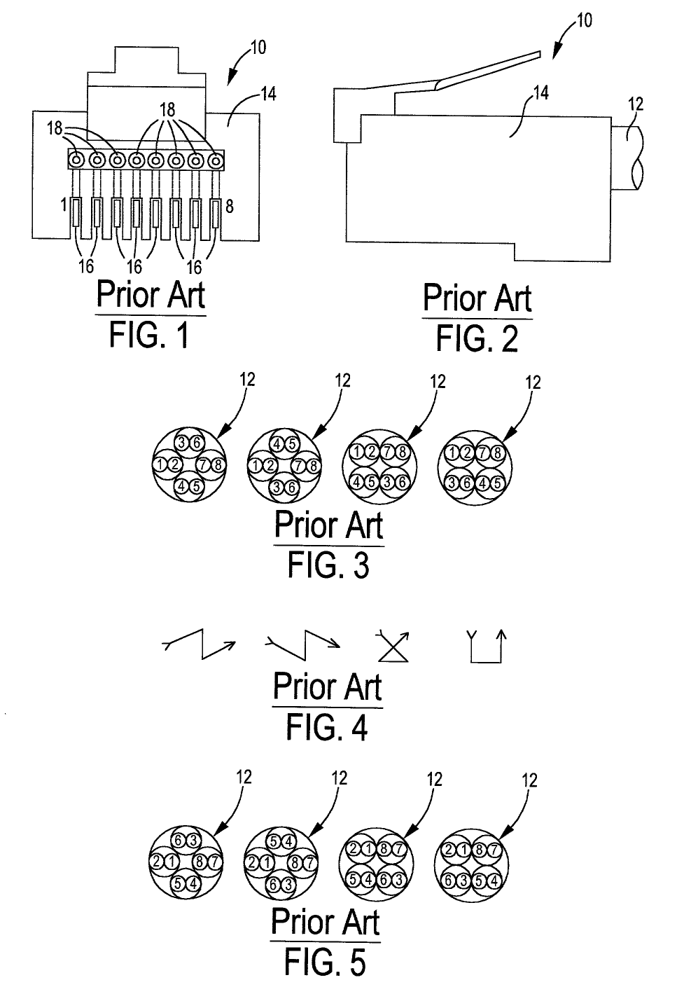

### DESCRIPTION

While the present invention may be susceptible to embodiment in different forms, there is shown in the drawings, and herein will be described in detail, an embodiment thereof with the understanding that the present description is to be considered an exemplification of the principles of the invention and is not intended to limit the invention to that as illustrated and described herein.

An embodiment of the present invention provides a cable and method of constructing same, where the cable has stable electrical characteristics so that handling and movement of the cable will not substantially change or alter the apparent “return loss” of the links that are being measured.

Conventional LAN cable is made by twisting, and sometimes bonding pairs of wires from insulated wires, and twisting four pairs together to form a cable. A sleeve is positioned over the four pairs. The dielectric thickness is adjusted, along with the wire diameter, so that the differential impedance of each pair of wires is close to 100 Ohms. Adjacent conductors, such as metal trays, wires, hands, etc. can lower the differential impedance of the cable. Instead of using eight wires, an embodiment of the present invention uses eight coaxial cables. The shields of pairs of 50 Ohm coaxial cables are connected together at the ends to form the desired 100 Ohm differential impedance. Since the impedance of the cable is set by the diameter of the inner conductors and the corresponding dielectric, the impedance is independent of proximity of adjacent pairs, or the proximity of hands or other conductive surfaces. As such, the stability of such a cable is improved over the prior art.

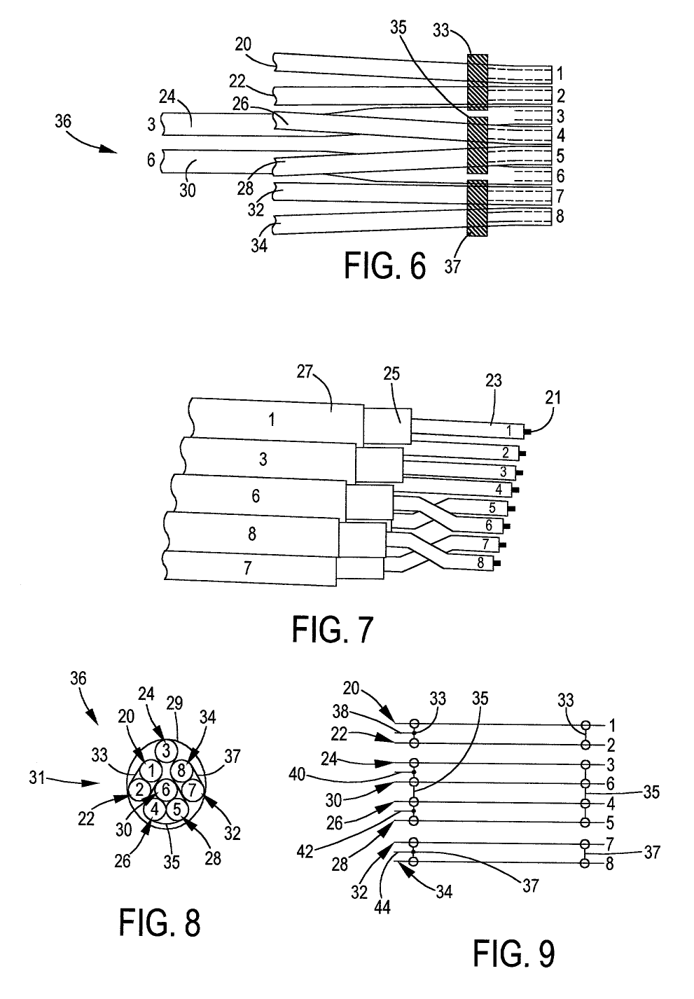

The success of the method of the present invention and the resulting apparatus depends on keeping the connection of the braided shield very short at both ends of the cable pairs. With reference to FIG. 6, a series of eight coaxial wires (20, 22, 24, 26, 28, 30, 32 and 34) are shown. As shown in FIG. 7, each of the coaxial wires includes a central conductor 21 centered inside and insulated (via insulator 23) from an outer tubular conductor 25 which is covered by an insulating jacket 27. The wires form a coaxial cable 36. As shown in FIGS. 6, 8 and 9, preferably cables 1 and 2 (20, 22) are paired, cables 3, 4, 5 and 6 (24, 26, 28, 30) are paired, and cables 7 and 8 (32, 34) are paired.

Alternatively, the pairings may be such that pins 1&2 form a pair, as do pins 3&6, pins 4&5, and finally pins 7&8. Regardless, preferably the four pairs of wires are covered by an outer sleeve 29 to form a cable 31 (see FIG. 8). The sleeve 29 may be an expanded braided material for any other form of suitable material which will not interfere with the desired objectives of the present invention.

When the wires are connected to a plug, such as an RJ45 connector, the outer conductor 25 or shield must be drawn back to reveal the inner conductor 21. When the shields are removed from a pair of wires (for example, 20, 22), for insertion into the plug 14, the “open” center conductors (21) should be dressed very short. This is because the conductors will be used up to 350 MHZ. Any conductors extending beyond or outside the shield will have a higher impedance than the desired 100 Ohms.

As described hereinabove, pairs of 50 Ohm coaxial wire provide the stability desired, by virtue of the impedance of each wire being more stable and nearly independent of proximity of the conductors external to the shield or each coax. When the shields of each pair at the end in the connector are connected together with short links of copper tape, i.e. as shown in FIG. 6, coax 1 and 2 by 33, coax 3, 4, 5 and 6 by 35, and coax 7 and 8 by 37, respectively, the combined pair of coaxial cables provides a 100 Ohm impedance. This impedance reading is independent of what is in the proximity of the cable. Short wires connecting the ends of the shields together has the effect of adding series inductance, degrading the high frequency performance. Therefore, it is imperative that these connections that connect the ends of the coax shields together be as short as possible. Copper foil is preferred. With reference to FIG. 9, short wires 38, 40, 42, 44, are attached to the copper foils 33, 35 and 37. In use, the short wires 38, 40, 42, 44 are tied to the test instrument ground.

Compared to the prior art, the advantages of the present invention are that handling of the cable by users does not alter the measurements associated therewith. In other words, for the apparatus of the present invention is insensitive to the proximity of user's hands relative thereto. Additionally, when the cables are constructed of eight conductors of coaxial cable, the cables exhibit much less change when flexing and twisting.

Another advantage of the use of coaxial wire pairs is that the conductors can always be oriented the same way when entering a plug. In contrast, prior art cables may have different orientations from one end to the other. Additionally, with regard to prior art devices, there is no specification as to what the order of the pair should be within a cable. For example, with conventional cable, the wire pairs may be in any orientation (see FIGS. 3, 4 and 5). If a different configuration is required for attachment to a plug, the pairs will have to be moved around in the plug, which will change the crosstalk, both near end crosstalk (“NEXT”) and far end crosstalk (“FEXT”).

Some testing of the wire indicates that the wire can be flexed with variations in “return loss” equivalent to about 1 Ohm. This is important information such that the “return loss” related to the present invention is approximately 10% of what would be expected for other prior art cables. Additionally, the initial impedance was quite close to 100 Ohms.

When pairs of 50 Ohm coaxial cables are used with shields connected together at both ends, the desired 100 Ohms differential impedance results. Because of the shielding on each coaxial wire, coaxial cable impedance is essentially independent of proximity of conductors outside of the coax shield. This includes hands and metal surfaces. Cables made from eight coaxial cables and connected together properly are much more stable when measuring “return loss” as the cable is handled, moved, flexed and twisted. Individual conductors can be repeatedly and consistently assembled in the plug, giving more consistent results from one assembly to the next. Test instruments can make stable measurements including “return loss” measurements when using test cable consisting of eight coax conductors properly connected together to connect to cable installations being measured. Attenuation or insertion loss of the test cables on test instruments, while more than conventional cable, can be compensated for by means of calibration of the instrument.

The common mode impedance of a coaxial cable pair will be approximately 25 Ohms. The common mode impedance of conventional cable is approximately 75-100 Ohms. If necessary, ferrite cores can be placed around each pair to raise the common mode impedance of each pair.

While an embodiment of the present invention is shown and described, it is envisioned that those skilled in the art may devise various modifications of the present invention without departing from the spirit and scope of the appended claims.

What is claimed is:

1. A cable for testing a network, said cable comprising: a sleeve; a plurality of coaxial cables disposed in the sleeve, each coaxial cable including a central conductor, an outer tubular conductor and an insulating jacket, wherein said central conductor is inside and is insulated from said outer tubular conductor, and wherein said outer tubular conductor is covered by said insulating jacket; and a plurality of metal strips, wherein each of said metal strips is wrapped around at least a portion of a plurality of coaxial cables to provide a desired impedance.

2. A cable as recited in claim 1, wherein each coaxial cable further includes an insulator disposed between said central conductor and said outer tubular conductor.

3. A cable as recited in claim 1, wherein said cable includes eight coaxial cables.

4. A cable as recited in claim 1, further comprising three metal strips, a first metal strip which is wrapped around two coaxial cables, a second metal strip which is wrapped around two coaxial cables, and a third metal strip which is wrapped around four coaxial cables.

5. A cable as recited in claim 1, wherein each of said coaxial cables has an impedance of 50 Ohms.

6. A cable as recited in claim 1, wherein each of the metal strips comprises a copper foil strip.

7. A cable as recited in claim 1, further comprising wires connected to the metal strips.

8. A cable as recited in claim 1, wherein said cable includes eight coaxial cables each having an impedance of 50 Ohms, said cable including three metal strips, a first metal strip which is wrapped around two coaxial cables, a second metal strip which is wrapped around two coaxial cables, and a third metal strip which is wrapped around four coaxial cables.

9. A cable for testing a network, said cable comprising: a sleeve; eight 50 Ohm coaxial cables disposed in the sleeve, each coaxial cable including a central conductor, an insulator, an outer tubular conductor, and an insulating jacket, wherein said central conductor is inside and is insulated from said outer tubular conductor, said insulator being disposed between said central conductor and said outer tubular conductor, and wherein said outer tubular conductor is covered by said insulating jacket; and three copper foil strips, wherein a first copper foil strip is wrapped around two coaxial cables, a second copper foil strip is wrapped around two coaxial cables, and a third copper foil strip is wrapped around four coaxial cables.
